(19) United States
(12) Patent Application Publication
(10) Pub. No.: US 2010/0052459 A1
(43) Pub. Date: Mar. 4, 2010

(54) Electromagnetic force motor

(76) Inventor: James Arthur Rush, Houston, TX (US)

Correspondence Address: James Rush, 19200 Space Center Blvd, Apt 2721, Houston, TX, 77058, US

(21) Appl. No.: 12/231,025

(22) Filed: Aug. 28, 2008

(51) Int. Cl. H02K 17/12

(52) U.S. Cl. 310/166

(57) ABSTRACT

An electromagnetic force motor includes a stator having a plurality of magnets mounted along a perimeter of the rotor. Preferably, the stator magnets have opposite poles isolated from each other and pointed inward towards the rotor. The rotor will preferably have two appendages. The 1st appendage (called the major appendage for this design) will consist of a highly ferrous, magnetic material with tightly wound coils that will form a magnetic field when introduced to a magnetic field that is generated and collapsed at a frequency of from 0 to 50 khz. The 2nd appendage (called the minor appendage for this design) will consist of a highly ferrous, magnetic material, with a dimension less than or greater than but not the same as the 1st appendage with tightly wound coils numbered more than or less than but not the same as the 1st appendage. The number of appendages on the rotor may be increased or decreased as required. The number of appendages may vary from 1 to infinity. The height of the appendages is limited by the inside of the inside diameter of the motor housing chamber. The rotor will be attached to the drive shaft. The drive shaft will be constructed with non-ferrous material. The inner chamber of the motor that houses the rotor will be filled with a medium that will be used as a dielectric. This medium may vary from air to magnetic liquids. This project will use synthetic oil rated at 5W-30. This medium was chosen because the thermal rating exceeds the curie temperature of a magnet. The stator consists of low voltage high current magnetic blocks located a determined number of degrees apart from each other. These magnetic blocks will be sequenced on at a rate of 0-50 khz for this design. Higher rates may be used for future designs to increase the torque to horsepower ratio. The low voltage high current magnetic blocks will be controlled by controller digital outputs capable of sequencing on/off at a rate sufficient to satisfy the design.

### BACKGROUND AND SUMMARY OF THE INVENTION

This invention relates to the field of electromagnetic motors, and specifically to electromagnetic motors in which a rotor having electromagnets called appendages for this design rotates by the on and off sequencing of low-dc voltage high dc-current integrated magnetic blocks located on the stator.

One object of the invention is to provide mechanical motive power. An additional object of the invention is to provide high-speed mechanical motive power, wherein electrical input power consumption is reduced as mechanical speed of rotation increases.

In order to realize these and other objectives, an apparatus in accordance with the invention is provided comprising a rotor having a perimeter, a plurality of electromagnets mounted on the perimeter of the stator, an electromagnet disposed adjacent to the perimeter of the motor, and means for sequencing the electromagnets in a predetermined phase relationship with rotation of the rotor, whereby magnetic attraction and repulsion between the electromagnet and the plurality of magnets cause the rotor to rotate. The varying frequency applied to the low voltage high current integrated magnetic blocks determines the dielectric strength of the medium as well as the strength of the developed magnetic strength of the appendages on the rotor. The increasing/decreasing dielectric and the increasing/decreasing developed magnetic strength vary the developed torque on the rotor. The body of the rotor acts like an accumulator. The accumulator will regulate minor changes in the magnetic particle changes due to the changing load. Major changes to the magnetic field will be a function of the increase and decrease of frequency that is predicated on major fluctuations of the load.

### BRIEF DESCRIPTION OF THE DRAWINGS

Other objects, advantages and novel features of the present invention will become apparent from the following detailed description of the invention when considered in conjunction with the accompanying drawings, in which:

FIG. 1 is a front view of an apparatus according to the invention;

FIG. 2 is a side view of a rotor and stator low voltage high current electromagnetic blocks used in the apparatus of FIG. 1;

FIG. 3 is a perspective view of the low voltage high current electromagnetic blocks of FIG. 2;

FIG. 4 is a perspective view of a rotor with electromagnetic appendages on the rotor of FIGS. 2 and 3;

### DETAILED DESCRIPTION OF THE INVENTION

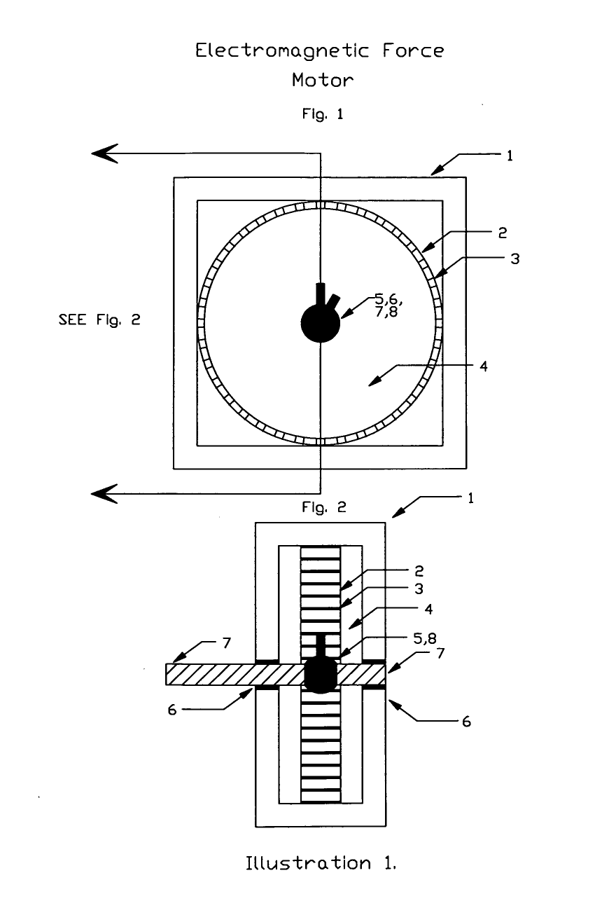

FIG. 1 shows a front view of an apparatus according to the invention. A front view shows the housing 1, the stator 2 and 3, the environment 4 and the rotor 5,6 and 7. A generally circular rotor with appendages is shown in an edge view, is supported by and rotates around an axle 7. The rotor 5 is preferably made of a highly magnetically conductive material. The axle seal 6 and the axle 7 is preferably a non-magnetically conductive material such as a neodymium iron boron alloy supported in and allowed to rotate through seals 6 mounted in the housing. One or more low voltage high current integrated electromagnet blocks 2 and 3 are mounted by suitable means in the housing 1 so that they are disposed near the rotor 5. While 36 low voltage high current integrated electromagnet blocks 2 and 3 separated by a non-conductive isolator barrier are shown in FIG. 1, any suitable number may be employed. Also, while the low voltage high current integrated electromagnet blocks 2 and 3 may all be disposed on a same side of the rotor 5, in the present embodiment in FIG. 1, low voltage high current integrated electromagnet blocks 2 and 3 are disposed on either side of the rotor 5. In a preferred embodiment, the low voltage high current integrated electromagnet blocks 2 and 3 are U-shaped. Coils are wound around the appendages 8 which are located on rotor 5. As will be described in detail below, the low voltage high current electromagnetic blocks 2 and 3 cause magnetic particles to be induced into the environment 4. Sequencing the low voltage high current integrated electromagnet blocks 2 and 3 on and off forces the magnetic particles to align and develop an electromagnetic field of force. The field of force will induce a counter emf force in the appendages 8 on the rotor 5. The magnetic attraction-repulsion of identical poles will force rotation of the rotor in the direction controlled by the sequencing of the low voltage high current integrated electromagnet blocks 2 and 3 mounted on the stator. A grounded shield 12 may be employed to enclose the entire apparatus.

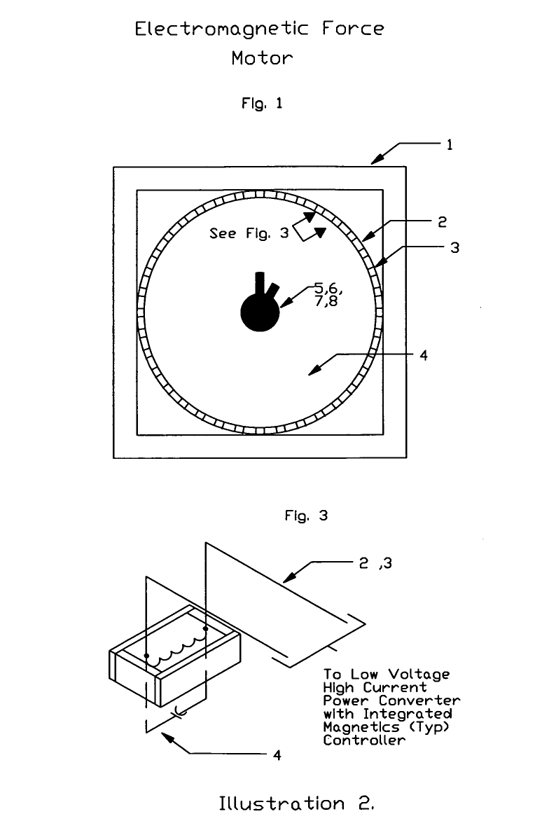

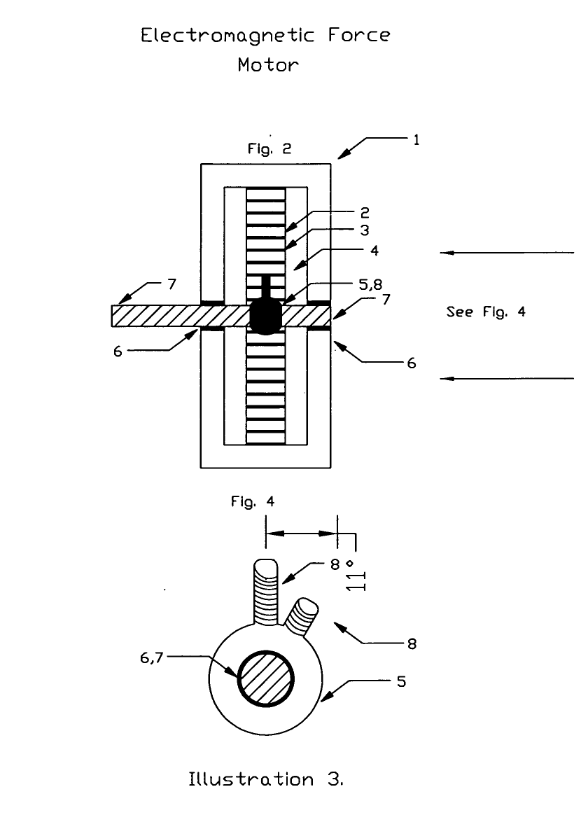

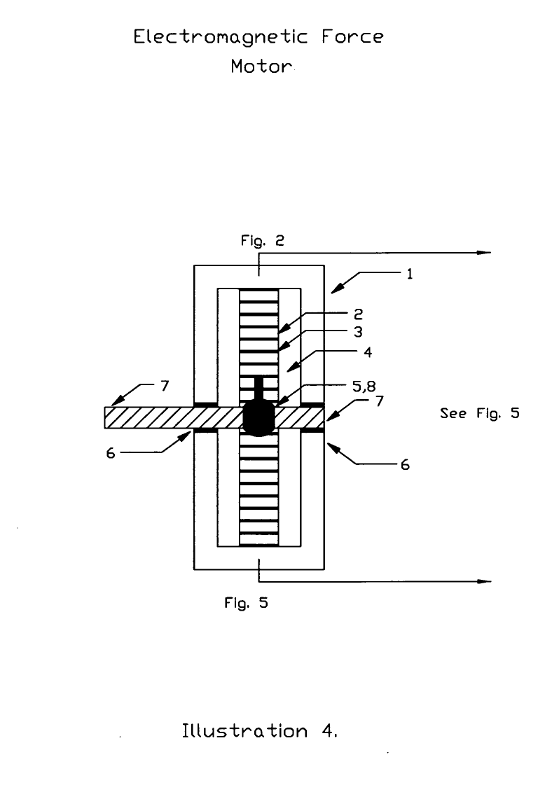

FIG. 2 shows a perspective view of the rotor 5 according to a first preferred embodiment of the invention. FIG. 2 shows a non-magnetic housing I that contains the stator, the rotor and the environment. FIG. 2 shows a side view of the rotor 2, and a perspective view of the stator 2 and 3. A plurality of 36 low voltage high current integrated electromagnet blocks 2 and 3 are provided around a perimeter of the rotor 5, In the preferred embodiment, the slots are arranged around the perimeter 36 end-to-end to suggest the shape of a circle. In the illustrated embodiment, 36 slots are shown, thus suggesting the shape of a circle.

FIG. 3 shows a perspective view of the low voltage high current integrated electromagnetic block 2 and 3. Electrical leads from a controller point control the low voltage high current integrated electromagnetic block 2 and 3. There is 36 low voltage high current integrated electromagnetic blocks 2 and 3 for this design. A developed capacitor is shown on the rotor 5, which represents the environment, 4 dielectric properties.

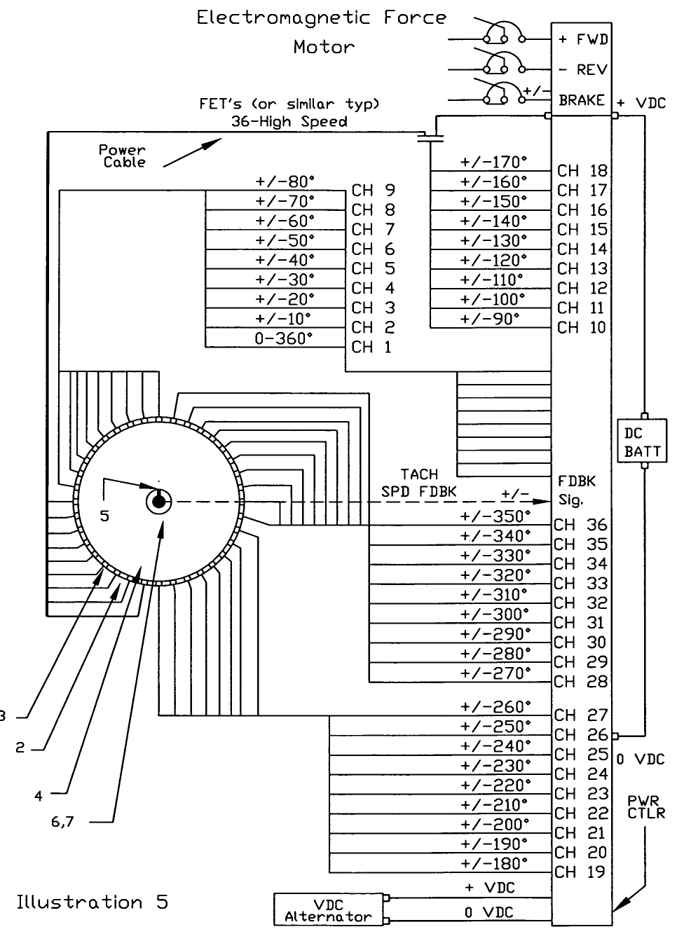

FIG. 4 shows the rotor 5 with tightly wound appendages 8. The rotor's body, shown circular for this design, will act as an accumulator for magnetic particles. The body can be of any shape. The axle and seals, 7 and 8, are attached to the rotor 8.

Theory of Operation:

The theory of operation is to develop torque in the rotor 8 by creating and collapsing a magnetic field in an environment 4 that surrounds the rotor. The created magnetic field will rotate in either a clockwise or counterclockwise fashion depending on the design. For this design the low voltage high current electromagnetic blocks 2 and 3 are sequenced on and off in a clockwise direction. For this design the low voltage high current electromagnetic block 2 and 3 located in the 10° positions will be sequenced on. The low voltage high current electromagnetic block 2 and 3 located in the 190° position will turn on next. See illustration 5. The mechanical concept of this design is similar to that of a bicycle. The pedals on a bike are located 180° apart and are attached to a drive train The energy to motor the bike comes from the force applied, by the bicyclist, to the pedals and the translation this force to the wheels via a gear train. The miles per hour attained during the cycling are controlled by the amount of energy that is applied to the bicycle by the bicyclist. This design turns on a low voltage high current electromagnetic blocks 2 and 3 located in the 0° position which sets a positive polarity on the stator plate. Some time later, prior to turning off the low voltage high current electromagnetic block 2 and 3 located position 0°; the low voltage high current electromagnetic block 2 and 3 located in position 180° is sequenced on. This sets the stator plate at 180° to a minus polarity in relation to the block located in position 0°. The low voltage high current electromagnetic block 2 and 3 located in position's 10° and 190° followed by 20°-200°, 30°-210°, 40°-220°, 50°-230°, 60°-240°, 70°-250°, 80°-260°, 90°-270°, 100°-280°, 110°-290°, 120°-300°, 130°-310°, 140°-320°, 150°-330°, 160°-340°, 170°-350° and 180V-360° are sequenced on and off. The sequencing control is provided by a controller capable of a sequencing rate of 0-50 Khz per 100 segments. Torque is developed as the frequency of the magnetic particles, introduced and trapped in the environment 4 by the creation and collapsing of a magnetic field via the low voltage high current electromagnetic blocks 2 and 3 located on the stator changes. The buildup of the magnetic particles aligns with the rotating plates on the stator. The rotational frequency of the stator will be maximized in a way that the magnetic particles in the controlled magnetic force field cuts the windings on the appendages 8 located on the rotor 5 develops a voltage with a strength capable of either repulsing or attracting the appendage 8 to or from the force applied by the stator low voltage high current electromagnetic blocks 2 and 3. The standard laws of capacitance and inductance will apply to this design. The increase in frequency cause a reduction in the dielectric of the environment while the increase in frequency develops a stronger magnetic force field in the rotor 5 appendages 8. The increase and decrease of dielectric and magnetic strength determines the applied torque. A signal to establish the required speed will be entered into the controller. A tachometer will monitor shaft rotation and supply a feedback signal to the controller. A comparison of these signals will determine the frequency necessary to control the applied torque.

What is claimed is:

1. An electromagnetic force motor comprising:
a rotor mounted for rotation about an axis;
a plurality of generally elongated appendage(s) mounted on said rotor in a general arrangement, so as to form a generally capacitive/inductive force field distribution to said electromagnets magnets about said axis. The first appendage of the of said rotor will develop a north magnetic polarity and a second appendage of the rotor will develop a south magnetic polarity, and any additional appendages will develop plus or minus polarities based on the action and reaction of the developed force field;
The rotor, with appendages, when excited by a developing and then crashing magnetic field will create a voltage of equal proportion to the applied voltage. This voltage will develop on the rotor appendages as the centripetal force of the electrons in the rotor housing are accelerated by the rotation of the voltage on the stator are aligned in such a way as to establish a north and south pole based on the polarity of the sequenced integrated magnets mounted on the stator.
The stator will be comprised of low voltage high current dc blocks capable of being sequenced on and off at a rate of 0-50 khz for this design. There will be thirty-six low voltage high current integrated dc blocks spaced at 10-degree intervals for this design. The first eighteen low voltage high current dc blocks will be oriented in such a manner that each positive end of the blocks is identically situated; an exact alignment is preferred but not required. The next eighteen low voltage high current dc blocks will be oriented in such a manner that each negative end of the blocks is identically situated; an exact alignment is preferred but not required.
A housing, hence forth referred to as the motor housing, will consist of the highly ferrous, magnetic material with tightly wound coils referred to as the rotor, a drive shaft that extends through the motor housing that is constructed with a non-magnetic material for this design. The drive shaft may be designed with magnetic material and steps will be taken to restrict magnetic leakage. An environment will be enclosed in the motor housing that will allow for the free movement of magnetic particles. A synthetic oil rated as 5w-30 has been selected for this design. There is no limit on the types of medium that can be used as an environment. The housing will be designed for the replacement of the environment when required. The housing for this design requires grounding to prevent static discharge.

2. An electromagnetic force motor according to claim 1, wherein the major appendage's magnetic polarity of said pole of said respective electromagnet is controlled so as to be the same as the magnetic polarity of the outwardly facing elongated face of a respective low voltage high current dc integrated magnetic blocks that are located on the stator.

3. An electromagnetic force motor according to claim 1, wherein the minor appendage's magnetic polarity of said pole of said respective electromagnet is controlled so as to be the opposite as the magnetic polarity of the outwardly facing elongated face of a respective low voltage high current dc integrated magnetic blocks that are located on the stator.

4. An electromagnetic motor according to claim 1, wherein the environment of the motor housing is of such a nature as to allow the realignment of the existing and introduced magnetic particles to aligned themselves in such a fashion as to create a rotating magnetic field.

5. An electromagnetic force motor according to claims 1 thru 4:
a rotor mounted for rotation about an axis;
Major appendage(s) consisting of a highly ferrous, magnetic material with tightly wound coils constructed as described in the abstract that are mounted on the rotor in a general arrangement, so as to form a generally north magnetic polarity and minor appendage(s) consisting of a highly ferrous, magnetic material with tightly wound coils constructed as described in the abstract that are mounted on the rotor in a general arrangement, the major and minor appendage for this design will be constructed eleven degrees apart from each other. The body of the rotor will be circular for this design and will act as an accumulator by accepting and distributing magnetic particles as required to provide the variable torque conditions. The circular design may be modified to that of an ellipse, square, polygon or any other type of design with the same results.
A stator;
Consisting of low-dc voltage high dc-current integrated magnetic blocks with the blocks aligned in such a manner as to create a rotating magnetic field by sequencing the low-dc voltage high dc-current integrated magnetic blocks on and off at a rate of 0-50 khz switching for this design. The low-dc voltage high dc-current integrated magnetic blocks will be sequenced on and off in such a manner as to distribute the magnetic particles gathered in the motor housing in the most efficient manner. For this design, when one of the low-dc voltage high dc-current integrated magnetic blocks is phased on, for example the block located at the 10° position, the corresponding block located at 190°, will turn on a while later. This will create the north-south pole effect necessary to force the rotor to revolve around the axis. In the next sequence, the block located at the 10° and the 190° positions will be sequenced off and the blocks located in the 20° and 200° positions will be sequenced on. This pattern of sequencing will continue around the stator in such a manner as to create an apparent, circular motion. This design will be programmed to accommodate and sequencing pattern without changing the design.
A motor housing;
The housing will the rotor, low-dc voltage high dc-current integrated magnetic blocks called the stator and environment also known as the magnetic particle collection medium.

6. For this design based on items 1 through 5, an electromagnetic force motor that develops an electromagnetic force field by building than collapsing a field that introduces magnetic particles into a medium called the environment. For this design, thirty-six low-dc voltage high dc-current integrated magnetic blocks, each constructed to occupy ten degrees of a circle are mounted in a way that they are located on the housing and is called the stator. For this design, the stator will be controlled at 0-50 Khz. Higher or lower frequency ranges may be used without affecting the design. The sequencing patterns of the stator may be modified without affecting the design.
